(19) United States
(12) Patent Application Publication
(10) Pub. No.: US 2008/0271302 A1
(43) Pub. Date: Nov. 6, 2008

(54) Machining center

(75) Inventors: Robert Betzig, Ann Arbor, MI (US); Brian Singleton, Jackson, MI (US)

Correspondence Address: Brinks Hofer Gilson & Lione/Ann Arbor, 524 South Main Street, Suite 200, Ann Arbor, MI, 48104, US

(73) Assignee: Ann Arbor Machine Company

(21) Appl. No.: 11/799,818

(22) Filed: May 3, 2007

(51) Int. Cl. B23P 21/00

(52) U.S. Cl. 29/430; 198/346.1; 414/222.07; 901/50

(57) ABSTRACT

A machining center is provided enabling a high degree of machining automation. The machining center includes a master machining head including multiple spindles mounted fixedly to the machining base. A workpiece transport system transports workpieces between machining stations and also moves it toward and away from the machining stations which are preferable fixedly mounted. Registration pins mounted to the master machine head register with a receiving socket carried by the workpiece platform or associated workpiece fixture. A robot actuator is provided which loads and unloads workpieces with the machining center 10 and can also potentially provide other functions such as tool inspection tool changing, workpiece repositioning.

### FIELD OF THE INVENTION

This invention relates to a highly automated machining center for factory automation particularly adapted for forming metal parts.

### BACKGROUND OF THE INVENTION

Industrial engineers have long sought to design machining operations for factories which provide low cost, high throughput, machining accuracy with high levels of quality control. In today's economic climate, particularly for Western countries, labor costs remain a very high component of the cost of producing finished goods. The hourly labor costs in some countries can be as low as one-tenth of that in Western countries. This imbalance in labor cost greatly favors developing nations in the manufacture of finished goods for use throughout the world. To address these economic factors, industrial engineers have developed many advanced manufacturing systems which use factory automation, including sophisticated robots which handle parts and position them for machining as well as inspection, packaging, and other operations. To date, however, machine operations have not reduced human labor requirements to the extent possible, and thus the cost imbalance mentioned previously continues to be a factor. Moreover, highly automated machining systems presently available tend to be complex, costly and unreliable.

In accordance with the foregoing, a need exists to provide factory automation systems providing higher degrees of automation to minimize human labor requirements while minimizing system complexity.

### SUMMARY OF THE INVENTION

The factory automation system of the present invention is in the form of an automated machining center. The machining center of the present invention utilizes a base with a fixed master head which provides multiple machining stations. Preferably the master head is mounted in a stationary manner to the machining base. A slide track is provided with fixturing for holding a workpiece. The slide track is able to move the workpiece between individual work stations along the master head and preferably moves toward the master head to engage registration pins carried by the master head for positioning the workpiece relative to machining spindles. The workpiece is thus translated on slides in two orthogonal directions, in one direction between adjacent machining heads and the other direction to a machining position and a displaced position in an unload position away from the machine head where it can be indexed to the next machining station position. A robot is provided preferably positioned to a base behind the master head and provides a multitude of functions. For example, the robot end effector could be used for gauging individual tools held by the machining spindles and provide tool changing if necessary. The robot is also capable of picking and placing workpieces onto fixturing carried by the workpiece platform. The robot end-of-arm-tooling or “end effector” could also be used to clean workpieces and machines by blowing air or fluid across them, and may perhaps also engage the workpiece or fixturing associated with the workpiece to move the machine platform between the indexed machining positions.

The machining center in accordance with this invention is capable of providing an extraordinary degree of automation and is capable of virtual elimination of human operator requirement. An idealized fully automated machining system in accordance with this invention could be operated in a “lights out” manner since human intervention and control is practically eliminated.

Additional benefits and advantages of the present invention will become apparent to those skilled in the art to which the present invention relates from the subsequent description of the preferred embodiment and the appended claims, taken in conjunction with the accompanying drawings.

### BRIEF DESCRIPTION OF DRAWINGS

FIG. 1 is a pictorial view of a machining center in accordance with the present invention;

FIG. 2 is a side view of the machining center shown in FIG. 1; and

FIG. 3 is a top view of the machining center shown in FIG. 1.

### DETAILED DESCRIPTION OF THE INVENTION

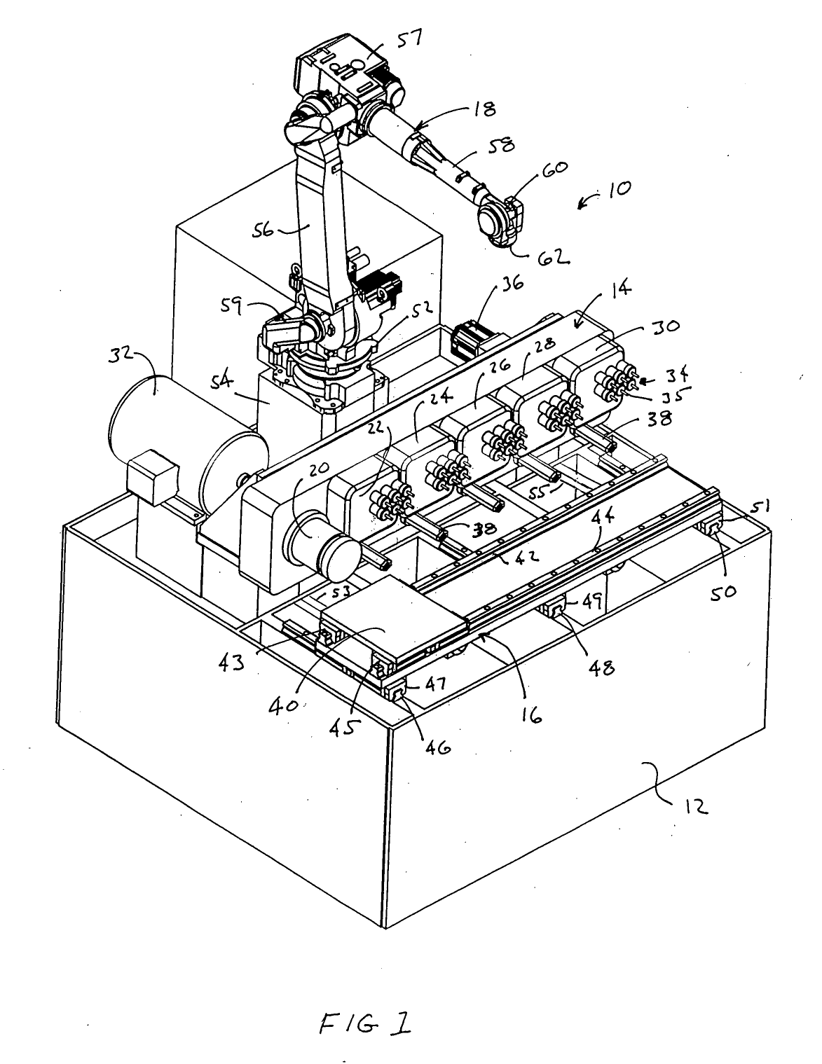

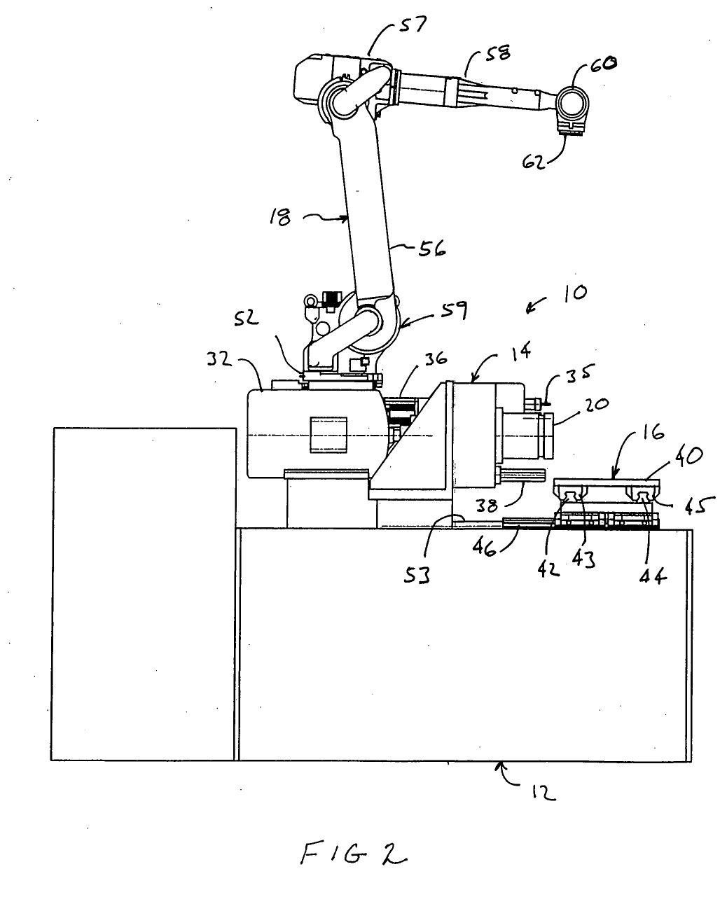

A machining center in accordance with the present invention is illustrated in FIGS. 1 through 3 and is generally designated by referenced number 10. Machining center 10 generally comprises machine base 12, master machining head 14, workpiece transport system 16, and robot actuator 18.

Machine base 12 provides a structural support for the remaining components of machining center 10 and is designed to be mounted to a factory floor. Machine base 12 would typically incorporate a subsystem for collecting machining fluids used in the machining operations of workpieces which can be oil or water based emulsion-type cutting fluids. A cutting fluid handling system (not shown) is provided for the collection, filtration, and transport of the machining fluids. Machine base 12 can be configured for standardized positioning on the workpiece floor for integration with other factory processing and automation systems.

Master machining head 14 illustrated in the figures provides a number of machining stations; six of which are shown in the figures designated by reference numbers 20, 22, 24, 26, 28, and 30. Preferably, master machining head 14 is driven by a single electric motor 32 and is fixedly mounted to machining base 12. In accordance with one feature of a preferred embodiment of this invention, workpieces as will be described below, are moved toward and away from each of the machining stations and indexed between the machining stations without requiring master machine head 14 to be moved relative to machine base 12. Master machining head 14 as illustrated in the figures provides for the separate machining stations 20 through 30 to be oriented in a linear fashion along its length. In this configuration, workpieces are moved in the linear manner from one end of the machine to the other during machining operations. However, it is within the scope of the present invention to provide other configurations of machining center 10 which might utilize the workpieces traveling in an arc or circular direction between machining stations rather than linearly translated.

This invention is not limited to particular types of operations carried out by each of the machining stations 20 through 30. However, for purposes of illustration, machining station 20 is illustrated as a milling station which might mill a face on one side of a workpiece. The subsequent work stations 22 through 30 are each illustrated having multiple gang spindles 34 which can incorporate any number of tools, such as drills, reamers, grinders, polishers, etc. For illustration, drills 35 are shown chucked into the spindles 34. In a preferred implementation of the present invention, each of the spindles of multiple gang spindle assembly 34 are fixed to master machine head 12 and are not independently mounted for stroking or lateral movement, although such actuation could be provided if needed in the machining of particular workpieces.

As mentioned previously, it is preferred that a single electric motor 32 is used to provide power for master machine head 14. Electric motor 32 could be coupled to all of the spindles of the machining stations 20 through 30 to run them at desired speeds in a continuous manner. Accordingly, in operation of machine center 10, all of the spindles of the machine could be rotating during machining operation. There may be machining operations which would require additional motors, which could be electric, pneumatic, or hydraulic or other types of drive systems. In the figures, an additional tapping motor 36 is illustrated which could be used for a thread tapping operation in which one of the spindles of the machining stations 22 through 30 includes a thread forming tool which is rotated and advanced in a precision manner to form internal (or external) threads on the workpiece.

By mounting master machine head in a fixed manner onto machine base 12, simplicity of design is provided for machining center 10. Since requiring the machining centers 20 through 30 to move relative to base 12 increases machine complexity.

Master machine head 14 includes a number of registration pins 38 extending in the same direction as the tools held by the various spindles of the machining stations. Registration pins 38 interfit with other components to provide proper location of the workpieces relative to the machining stations 20 through 30.

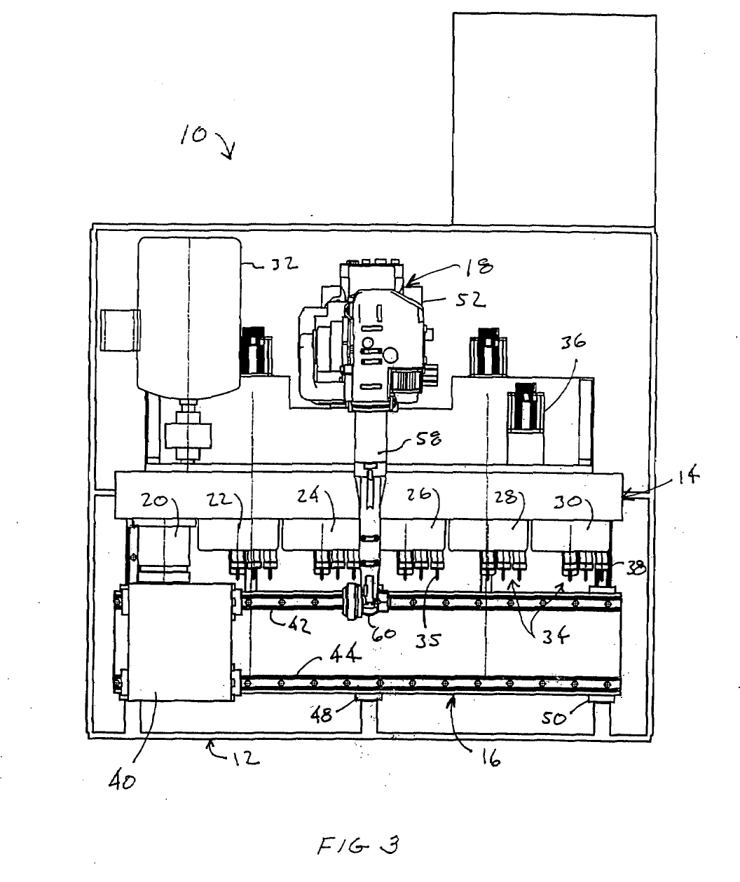

Workpiece transport system 16 includes workpiece platform 40 which is shown as a flat metal plate which is adapted for direct attachment to workpieces or more likely to mount a workpiece holding fixture in a fixed position relative to platform 40. The platform 40 would likely have tapped holes or other location features on its surface to enable for convenient attachment of workpieces or fixtures as mentioned previously. Workpiece platform 40 is mounted for sliding motion along a pair of T-rail slides 42 and 44. The lower surface of workpiece platform 40 includes the guides 43 and 45 which interfit with T-rail slides 42 and 44 to allow the platform to be moved from the left to the right hand ends of the machine as they are illustrated in FIGS. 1 and 3. Workpiece platform 40 can be free sliding along the T-rail slides 42 and 44 or may include a driven indexing system. These alternatives are discussed below in this specification.

The subassembly of workpiece transport 16, which includes platform 40 and T-rail slides 42 and 44 are in-turn mounted for translation toward and away from master machining head 14. Whereas workpiece platform 40 moves along T-rail slides 42 and 44 in one longitudinal direction, the platform is also translated in a perpendicular direction along T-rail slides 46, 48, and 50. Guide elements 47, 49, and 51 for T-rail slides 46, 48, and 50 respectively are attached to the bottom surface of T-rail slides 42 and 44. For reference, the motion of workpiece platform 40 along T-rail slides 42 and 44 is referred to as “station indexing movement” whereas the movement of workpiece transport 16 toward and away from master machine head 14 is referred to as workpiece unloading and machining movement.

In a preferred embodiment of the present invention, the movement of workpiece transport 16 in the machining unloading and direction is provided through a pair of ball screw actuators 53 and 55. Such actuators are well-known in the art. Various other types of linear actuators could also be used, including pneumatic, hydraulic, or electric rack-and-pinion type actuators.

Robot actuator 18 shown in the figures includes robot base 52 mounted to machining base platform 54. Robot actuator 18 is shown as including a pair of arms 56 and 58. Arm 56 is mounted to base 52 at shoulder joint 59 in a manner providing two degrees of angular motion, namely a first motion about a vertical axis and a second motion about a horizontal or lateral axis. Similarly, the “elbow” joint 57 between arms 56 and 58 also provides two degrees of controlled rotational motion (orthogonal to each other). At the end of arm 58, a wrist joint 60 is provided which itself provides two degrees of angular rotational motion. Thus, robot actuator 18 provides six degrees of angular motion control providing a high degree of positioning capabilities for an end effector (not shown) fastened to wrist receiver 62. Although a six axis robot actuator 18 is described, other types of robot actuators having greater or fewer degrees of freedom as well as others including telescoping motion of its arms could also be used depending upon the positioning flexibility required for a given machining application.

Robot actuators 18 provide enormous capabilities of accuracy, speed, and reliability. One aspect of the present invention is to take advantage of the continuously expanding capabilities of such existing industrial robot actuators 18. Robot actuators 18 typically have sophisticated on-board controller systems utilizing programmable logic controllers (PLC's) or more advanced digital motion control systems. These systems are also coupled with sensors on the robot for providing force or positioning feedback for highly precise applications. Such controllers for robot actuator 18 are also capable of controlling external machine functions which could include the various motions and machine functions described for machining center 10 previously described. Such additional motion and control could include controlling operation of motors 32 and 36 and the actuators for motion of workpiece transport 16. Various end effectors could be used for robot actuator 18, including ones for picking and placing workpieces, inspecting and changing tools, cleaning and washing parts, repositioning parts, and potentially indexing workpiece platform 40 between machining positions.

Now with reference to the figures, operation of machining center 10 will be described. In a representative machining operation, a workpiece (not shown) would be located on workpiece platform 40, either directly or through a receiving fixture (not shown). In an illustrative machining operation, the first station for machining is located in the left-hand side of the machine as shown in the drawings and a first operation is a milling step, shown at machining station 20.

After the workpiece is loaded, platform 40 is positioned at the location shown in the figures either through an internal linear actuator within the machine or perhaps through external means such as being controlled by robot actuator 18. Once in the position illustrated in the figures, ball screw actuators 53 and 55 are operated to stroke workpiece transport 16 toward machining stations 20 through 30. One of registration pins 38 engages with a precision receiver carried directly by workpiece platform 40 or by a parts holding fixture. Registration pins 38 are precisioned locating devices and their interfitting with the receiving sockets provides precision location of the workpiece relative to each of machining stations 20 through 30. The machining of the workpiece can occur only when the workpiece reaches a stopped position near the associated machining station, or as the workpiece is moved in a controlled manner to the fully displaced position near the machining station.

Once in a machining position, machining station 20 performs a machining operation on the workpiece which, in the case of this described system, is a milling operation. Once that machining operation is completed, workpiece transport 16 is actuated to move platform 40 back to its unloaded position shown in the figures and workpiece platform 40 is indexed to the next machining station 22. Again, the ball screw actuators 53 and 55 are actuated bringing the workpiece into a machining position interacting with the multiple gang spindles 34 of machining station 22. Ball screw actuators 53 and 55 provide precision and control of the position of the tools of multiple gang spindle 34 relative to the workpiece and its operation can be used to control machining rates of the spindle tools as they engage the workpiece. After machining at each of the individual stations, workpiece platform 40 is indexed to the subsequent station and finally after reaching machining station 30, the machining operation provided by machining center 10 is completed and the part may be unloaded, preferably by robot actuator 18.

Machining center 10 shown in the figures includes a single workpiece platform 40 and therefore only a single workpiece is machined at machining center 10 at any given time and only by one of the machining stations 20 through 30. However, in another application of the present invention, multiple workpiece platform 40 could be provided for enabling multiple workpieces to be machined simultaneously undergoing various of machining steps provided by machining center 10.

Robot actuator 18 can be used to provide numerous functions. For example, the workpieces can be picked from storage bins or workpiece conveyors and placed in position on workpiece platform 40. After machining operations, the workpieces can be unloaded from the workpiece platform 40 and loaded into other bins or into other machining centers for additional operations. Because of the enormous capabilities of currently available robot actuators 18, many more functions can also be provided. For example, as mentioned previously, the indexing of workpiece platform 40 between the machining positions can be provided by robot actuator 18. In that operation, an end effector would engage the workpiece, the workpiece platform 40, or the associated fixture to index it between the positions in registration with machining stations 20 through 30. In some machining operations, it may be necessary to reposition the workpiece during its machining operations by machining center 10. Accordingly, after one or more machining steps at a machining station, the workpiece could be removed from platform 40 and repositioned so that another face or feature of the workpiece can be machined. By using an appropriate end effector, robot actuator 18 could also be used to provide non-contact or contact inspection of the workpieces or the tools shown as representative drills 35. Through appropriate control, the tool spindles could be actuated to release a tool and allow new tools to be chucked, entirely through operation of robot actuator 18. A tool storage magazine (not shown) could be provided for allowing the robot to select and replace such tools. Robot actuator 18 could also clean workpieces by blowing air or fluids against them, brushing them, or other operations. The controller for robot actuator 18 could place a call for service if a machining interruption occurs. The completed assembly of machining center 10 could be covered by a top enclosure (not shown) to better contain cutting fluids and chips.

Another feature of machining center 10 is that as illustrated in the figures, on one side of the machine being divided by master machine head 14, the machine operations are provided where chips are generated and cutting fluid is presented which can be thought of as the “dirty” side of the machining center 10. The back side of the machine 10, as illustrated where robot actuator 18 is mounted, can be thought of as the “clean” side of the machine where the sensitive components of the robot actuator are present. This configuration is likely to provide improvements in machine reliability.

While the above description constitutes the preferred embodiment of the present invention, it will be appreciated that the invention is susceptible to modification, variation, and change without departing from the proper scope and fair meaning of the accompanying claims.

1. A machining center for machining workpieces, comprising:
a machine base,
a master machining head having a plurality of machining stations each having one or more spindles,
a workpiece transport having a workpiece platform for receiving and mounting a workpiece, the workpiece transport providing motion of the workpieces in two directions, including a first workpiece transport direction of motion between the workstations and a workpiece unloading and machining direction of motion between a workpiece unloading position displaced from one of the machining stations to a workpiece machining position adjacent to one of the machining stations, and
an actuator for moving the workpiece platform between the unloading and machining positions.

2. A machining center in accordance with claim 1, further comprising a robot actuator for providing one or more functions including; workpiece loading and unloading with the workpiece transport, and tool loading and unloading from the spindles.

3. A machining center in accordance with claim 1, further comprising the master machining head being elongated with the machining stations oriented generally along a line.

4. A machining center in accordance with claim 3 wherein the master machining head separates the machining center into two section including a first section on one side of the master machining head and a second section having a mounted robot actuator.

5. A machining center in accordance with claim 1, further comprising a motor for driving tools at more than one of the machining stations.

6. A machining center in accordance with claim 1, further comprising wherein the master machining head is fixedly attached to the machine base.

7. A machining center in accordance with claim 6, further comprising the actuator moving the workpiece relative to a work station such that machining of the workpiece occurs during the moving.

8. A machining center for machining workpieces, comprising:
a machine base,
a master machining head having a plurality of machining stations each having one or more spindles, the machining stations oriented in a linear direction and being fixed to the base,
a workpiece transport having a workpiece platform for receiving and mounting a workpiece, the workpiece transport providing motion of the workpieces in two directions, including a first workpiece transport direction between the workstations and a workpiece unloading and machining direction between a workpiece unloading position displaced from one of the machining stations to a workpiece machining position adjacent to the machining station,
an actuator for moving the workpiece platform between the unloading and machining positions, and
a robot actuator for providing one or more functions including; workpiece loading and unloading from the workpiece transport, and tool loading and unloading from the spindles.

9. A machining center in accordance with claim 8 wherein the master machining head separates the machining center into two section including a first section on one side of the master machining head and a second section having a mounted robot actuator.

10. A machining center in accordance with claim 8, further comprising a motor for driving tools at more than one of the machining stations.

11. A machining center in accordance with claim 8, further comprising the actuator moving the workpiece relative to a work station such that machining of the workpiece occurs during the moving.
